(19) United States
(12) Patent Application Publication
(10) Pub. No.: US 2022/0113418 A1
(43) Pub. Date: Apr. 14, 2022

(54) TARGET DETECTION METHOD, ELECTRONIC DEVICE, AND STORAGE MEDIUM

(71) Applicant: SENSETIME GROUP LIMITED, Hong Kong (CN)

(72) Inventors: Zhe WANG, Hong Kong (CN); Hui ZHOU, Hong Kong (CN); Jianping SHI, Hong Kong (CN)

(21) Appl. No.: 17/560,365

(22) Filed: Dec. 23, 2021

Related U.S. Application Data
(63) Continuation of application No. PCT/CN2021/090540, filed on Apr. 28, 2021.

(30) Foreign Application Priority Data
Jul. 22, 2020 (CN) 202010712662.7

(51) Int. Cl. G01S 17/58; G06T 7/521; G01S 7/481; G01S 7/48; G01S 7/4865; G01S 17/42

(52) U.S. Cl. CPC G01S 17/58; G06T 7/521; G01S 7/4817; G06T 2207/30241; G01S 7/4865; G01S 17/42; G06T 2207/10028; G01S 7/4808

(57) ABSTRACT

A target detection method is provided, which includes: a plurality of frames of point cloud data obtained through scanning by a radar apparatus and time information of each frame of point cloud data obtained through scanning are acquired; position information of a target to be detected is determined based on each frame of point cloud data; scanning direction angle information when the target to be detected is scanned by the radar apparatus in each frame of point cloud data is determined based on the position information of the target to be detected in each frame of point cloud data; and moving information of the target to be detected is determined according to the position information of the target to be detected, the scanning direction angle information when the target to be detected is scanned by the radar apparatus, and the time information of each frame of point cloud data.

### CROSS-REFERENCE TO RELATED APPLICATION

This application is a continuation application of International Application No. PCT/CN2021/090540, filed on Apr. 28, 2021, which claims priority to Chinese Application No. 202010712662.7, filed on Jul. 22, 2020. The contents of International Application No. PCT/CN2021/090540 and Chinese Application No. 202010712662.7 are hereby incorporated by reference in their entireties.

### BACKGROUND

At present, in a Motor Vehicle Auto Driving System (MVADS) or an Intelligent Vehicle Infrastructure Cooperative System (IVICS), lidar-based target detection has become more and more important. Lidar emits a laser beam to form a scanning section through rotary scanning, so as to acquire point cloud data.

When the moving information of a target is detected, the moving information of the target can be determined based on a scanning timestamp at which the target is scanned in each frame of point cloud data. In related technologies, the timestamp of the point cloud data is usually used as the scanning timestamp at which the target is scanned. Here, the end time of point cloud scanning can generally be selected as the timestamp of the point cloud data, or the middle time between the start time and the end time of the point cloud scanning can also be selected as the timestamp of the point cloud data.

However, no matter the timestamp of the point cloud data is determined in which of the abovementioned manners, the time when the target is scanned is actually different from the timestamp. Therefore, if the moving information of the target is stilled determined by adopting the abovementioned target detection solution, the detection accuracy will be low.

### SUMMARY

The present disclosure relates to the field of data processing technologies, and in particular, to a target detection method and apparatus, an electronic device, and a storage medium.

The embodiments of the present disclosure at least provide a target detection solution, which determines moving information of a target in combination with time information of each frame of point cloud data obtained through scanning and information related to a target to be detected in each frame of point cloud data.

In a first aspect, the embodiments of the present disclosure provide a target detection method. The method includes the following operations.

A plurality of frames of point cloud data obtained through scanning by a radar apparatus and time information of each frame of point cloud data obtained through scanning are acquired.

Position information of a target to be detected is determined based on each frame of point cloud data.

Scanning direction angle information when the target to be detected is scanned by the radar apparatus in each frame of point cloud data is determined based on the position information of the target to be detected in each frame of point cloud data.

Moving information of the target to be detected is determined according to the position information of the target to be detected in each frame of point cloud data, the scanning direction angle information when the target to be detected is scanned by the radar apparatus in each frame of point cloud data, and the time information of each frame of point cloud data obtained through scanning. In a second aspect, the embodiments of the present disclosure further provide a target detection apparatus. The device includes: an information acquisition module, a position determination module, a direction angle determination module, and a target detection module.

The information acquisition module is configured to acquire a plurality of frames of point cloud data obtained through scanning by a radar apparatus and time information of each frame of point cloud data obtained through scanning.

The position determination module is configured to determine position information of a target to be detected based on each frame of point cloud data.

The direction angle determination module is configured to determine scanning direction angle information of the target to be detected scanned by the radar apparatus in each frame of point cloud data based on the position information of the target to be detected in each frame of point cloud data.

The target detection module is configured to determine moving information of the target to be detected according to the position information of the target to be detected in each frame of point cloud data, the scanning direction angle information of the target to be detected scanned by the radar apparatus in each frame of point cloud data, and the time information of each frame of point cloud data obtained through scanning.

In a third aspect, the embodiments of the present disclosure further provide an electronic device, including a processor, a memory, and a bus. The memory stores a machine-readable instruction executable for the processor. When the electronic device runs, the processor communicates with the memory through a bus. The machine-readable instruction, when being executed by the processor, executes steps of the target detection method in the first aspect or any one of various implementations.

In a fourth aspect, the embodiments of the present disclosure further provide a computer-readable storage medium having a computer program is stored thereon. The computer program is run by the processor to execute steps of the target detection method in the first aspect or any one of various implementations.

In order to make the abovementioned purpose, characteristics, and advantages of the present disclosure clearer and easier to understand, detailed descriptions will be made below with the preferred embodiments in combination with the drawings.

### BRIEF DESCRIPTION OF THE DRAWINGS

For describing the technical solutions of the embodiments of the present disclosure more clearly, the drawings required to be used in the embodiments will be simply introduced below. The drawings, which are incorporated in and constitute a part of this specification, illustrate embodiments consistent with the present disclosure and, together with the specification, serve to explain the technical solutions of the present disclosure. It is to be understood that the following drawings only illustrate some embodiments of the present disclosure and thus should not be considered as limitation to the scope. Those of ordinary skill in the art may also obtain other related drawings according to these drawings without creative work.

FIG. 1 illustrates a flowchart of a target detection method provided by a first embodiment of the present disclosure.

FIG. 2 illustrates a schematic diagram of application of the target detection method provided by a first embodiment of the present disclosure.

FIG. 3A illustrates a schematic diagram of a grid matrix before coding provided by a first embodiment of the present disclosure.

FIG. 3B illustrates a schematic diagram of a sparse matrix provided by a first embodiment of the present disclosure.

FIG. 3C illustrates a schematic diagram of a grid matrix after coding provided by a first embodiment of the present disclosure.

FIG. 4A illustrates a schematic diagram of a grid matrix after left-shifting provided by a first embodiment of the present disclosure.

FIG. 4B illustrates a schematic diagram of a logical OR operation provided by a first embodiment of the present disclosure.

FIG. 5A illustrates a schematic diagram of a grid matrix after a first negation operation provided by a first embodiment of the present disclosure.

FIG. 5B illustrates a schematic diagram of a grid matrix after a convolution operation provided by a first embodiment of the present disclosure.

FIG. 6 illustrates a schematic diagram of a target detection apparatus provided by a second embodiment of the present disclosure.

FIG. 7 illustrates a schematic diagram of an electronic device provided by a third embodiment of the present disclosure.

### DETAILED DESCRIPTION

In order to make the purpose, technical solutions, and advantages of the present disclosure clearer, the technical solutions in the embodiments of the present disclosure are clearly and completely elaborated below in combination with the accompanying drawings of the present disclosure. It is apparent that the described embodiments are not all but only part of embodiments of the present disclosure. Components, described and shown in the accompanying drawings, of the embodiments of the present disclosure may usually be arranged and designed with various configurations. Therefore, the following detailed description of the embodiments of the present disclosure provided in the accompanying drawings is not intended to limit the scope of the present disclosure, but only represents the selected embodiments of the present disclosure. Based on the embodiments of the present disclosure, all other embodiments obtained by those skilled in the art without creative work shall fall within the scope of protection of the present disclosure.

It is found by research that when detecting the moving information of a target, the moving information of the target can be determined based on a scanning timestamp at which the target is scanned in each frame of point cloud data. In related technologies, the timestamp of the point cloud data is usually used as the scanning timestamp at which the target is scanned. However, based on an imaging principle of a lidar, it can be known that the time when the target is scanned is actually different from the timestamp of the point cloud data. If the moving information of the target is stilled determined by adopting the abovementioned target detection solution, the detection accuracy will be low.

Based on the abovementioned research, the present disclosure provides at least one target detection solution, which determines the moving information of the target in combination with the time information of each frame of point cloud data obtained through scanning and the information related to a target to be detected in each frame of point cloud data, and has high accuracy.

The defects existing in the solution of the related technologies are results obtained by the inventor after practice and careful research, thus both the problem discovery process and the solutions proposed for the above problems in the present disclosure below shall be the inventor's contribution to the present disclosure in the disclosure process.

It is to be noted that similar reference signs and letters represent similar terms in the following drawings and thus a certain term, once being defined in a drawing, are not required to be further defined and explained in subsequent drawings.

In order to facilitate the understanding of the embodiments, a target detection method disclosed in the embodiments of the present disclosure is first introduced in detail. The performing entity of the target detection method provided in the embodiments of the present disclosure is generally an electronic device with certain computing capacity. The electronic device includes, for example, a terminal device, a server or other processing devices. The terminal device may be User Equipment (UE), a mobile device, a user terminal, a terminal, a cell phone, a cordless phone, a Personal Digital Assistant (PDA), a handheld device, a computing device, a vehicle device, a wearable device, etc. In some possible implementation modes, the target detection method may be implemented by means of a processor calling a computer-readable instruction stored in the memory.

The target detection method provided by the embodiments of the present disclosure is described below by taking that performing entity is the terminal device as an example.

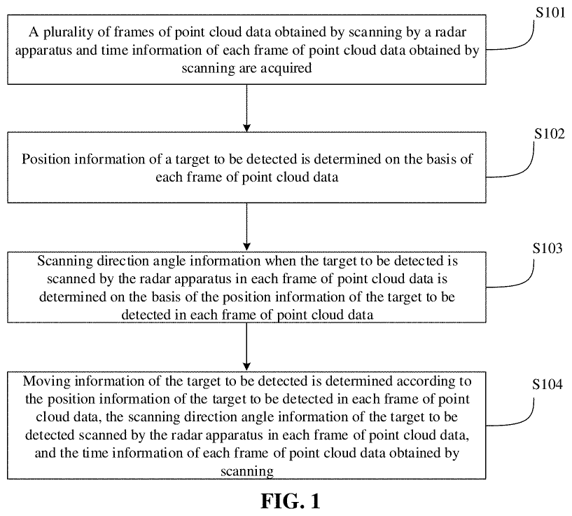

As shown in FIG. 1 which is a flowchart of a target detection method provided by an embodiment of the present disclosure. The method includes operations S101 to S104.

At S101, a plurality of frames of point cloud data obtained through scanning by a radar apparatus and time information of each frame of point cloud data obtained through scanning are acquired.

At S102, position information of a target to be detected is determined based on each frame of point cloud data.

At S103, scanning direction angle information when the target to be detected is scanned by the radar apparatus in each frame of point cloud data is determined based on the position information of the target to be detected in each frame of point cloud data.

At S104, moving information of the target to be detected is determined according to the position information of the target to be detected in each frame of point cloud data, the scanning direction angle information when the target to be detected is scanned by the radar apparatus in each frame of point cloud data, and the time information of each frame of point cloud data obtained through scanning.

Here, in order to facilitating understanding the target detection method provided by the embodiments of the present disclosure, a technical scenario of the target detection method is simply described first. The target detection method provided by the embodiments of the present disclosure may be applicable to a radar apparatus. Taking a rotary scanning radar as an example, point cloud data of a related target in a surrounding environment may be acquired when the rotary scanning radar rotates and scans in the horizontal direction. During rotating and scanning, a lidar may adopt a multi-line scanning mode. That is, a plurality of laser tubes are used for emitting sequentially, and the structure is that the plurality of laser tubes are arranged longitudinally. That is, during rotating and scanning in the horizontal direction, multi-layer scanning in the vertical direction is performed. There is a certain angle between every two laser tubes. A vertical emitting view field may be between 30° and 40°. Thus, a data packet returned by emitted laser of the plurality of laser tubes may be acquired when a lidar device rotates a scanning angle each time, and the point cloud data may be obtained by splicing the data packets acquired at various scanning angels.

It can be known from the abovementioned lidar scanning principle, the times when all targets are scanned by the lidar are different. If the timestamp of the point cloud data is directly considered as the timestamp common to all targets, a noise with the magnitude of T is introduced to the times tamp of the target, herein T is the time taken for the scanning of the frame of point cloud, which will cause poor accuracy for a determined moving target.

To solve this problem, the embodiments of the present disclosure provide a solution for determining the moving information of a target in combination with the time information of each frame of point cloud data obtained through scanning and information related to a target to be detected in each frame of point cloud data.

In the embodiments of the present disclosure, one frame of point cloud data may be a data set of various point-cloud points obtained by splicing the plurality of data packets scanned in one rotation cycle (corresponding to a rotation angle of 360°), may also be a data set of various point-cloud points obtained by splicing the data packets scanned in a half of a rotation cycle (corresponding to a rotation angle of 180°), or may also be a data set of various point-cloud points obtained by splicing the data packets scanned in a quarter of a rotation cycle (corresponding to a rotation angle of 90°).

Thus, after the position information of the target to be detected is determined based on each frame of point cloud data, the scanning direction angle information when the target to be detected is scanned in each frame of point cloud data may be determined based on the position information. The scanning time information when the target to be detected is detected in each frame of point cloud data may be determined based on offset angle information and the time information required for scanning one frame of point cloud data, and then the moving information of the target to be detected may be determined in combination with the position information of the target to be detected in each frame of point cloud data.

The scanning direction angle information corresponding to the abovementioned target to be detected may indicate an offset angle of the target to be detected relative to a defined forward X axis. For example, a scanning radar directly faces the target to be detected to start scanning, at this time, the position of the radar apparatus may be taken as an original point, and the direction pointing to the target to be detected may be taken as the forward X axis. At this time, the scanning direction angle for the target to be detected is 0°. If the target to be detected is offset from the forward X axis 15°, the corresponding scanning direction angle is 15°.

In specific application, the corresponding scanning direction angle information may be determined based on the position information of the target to be detected. Here, coordinate information may be correspondingly transformed into the corresponding scanning direction angle information based on a triangular cosine relation by taking the positive X axis defined above as the direction of 0°.

In the embodiments of the present disclosure, considering that each frame of point cloud data may be collected based on selection modes, such as a quarter of a rotation period, a half of a rotation period, or one rotation period, for one frame of point cloud data collected in different selection modes, the scanning start and end angle information thereof will affect the scanning time information when the target to be detected in one frame of point cloud data is scanned to a certain extent, and thus affecting the determination of the moving information. Therefore, different scanning start and end angle information determination methods may be adopted for different selection modes.

If the selection mode adopted in an embodiment of the present disclosure is one rotation cycle, the forward X axis may be taken as a scanning start angle. Thus, the scanning end angle corresponding to one rotation cycle is 360°, and related scanning start and end angle information may be determined directly or determined by using recorded results of a driver of the radar apparatus. If the selection mode adopted in an embodiment of the present disclosure is a half of or a quarter of a rotation cycle, at this time, the scanning start and end angle information corresponding to each frame of point cloud data is required to be determined. The scanning start angle and the scanning end angle in the scanning start and end angle information may be the offset angle relative to the forward X axis, and the related scanning start and end angle information may be determined by using the recorded results of the driver of the radar apparatus.

In the embodiments of the present disclosure, in the case that the time information of each frame of point cloud data obtained through scanning includes scanning start and end time information and scanning start and end angle information corresponding to each frame of point cloud data, the moving information of the target to be detected may be determined according to the position information of the target to be detected in each frame of point cloud data, the scanning direction angle information when the target to be detected is scanned by the radar apparatus in each frame of point cloud data, and the scanning start and end time information and the scanning start and end angle information corresponding to each frame of point cloud data.

The scanning start and end time information includes scanning start time information when the scanning of one frame of point cloud data is started and scanning end time information when the scanning of one frame of point cloud data is ended. The scanning start and end angle information includes scanning start angle information and scanning end angle information. The scanning start time information and the scanning start angle information may correspond to a scanning start position where the scanning of one frame of point cloud data is started. The scanning end time information and the scanning end angle information may correspond to a scanning end position where the scanning of one frame of point cloud data is ended.

In the case that the scanning direction angle information, the scanning start and end time information, and the scanning start and end angle information are determined, by taking the scanning start and end information as a reference, the moving information of the target to be detected may be determined by determining a state of the movement information of the target to be detected in which the target to be detected is located at the scanning position corresponding to the abovementioned scanning angle.

In the embodiments of the present disclosure, the moving information may be moving speed information. The moving speed information may be determined according to the following operations.

At S1, for each frame of point cloud data, scanning time information when the target to be detected is scanned in the frame of point cloud data is determined based on the scanning direction angle information when the target to be detected is scanned in the frame of point cloud data and the scanning start and end time information and the scanning start and end angle information corresponding to the frame of point cloud data.

At S2, displacement information of the target to be detected is determined based on coordinate information of the target to be detected in the plurality of frames of point cloud data.

At S3, moving speed information of the target to be detected is determined based on scanning time information when the target to be detected is scanned respectively in the plurality of frames of point cloud data and the displacement information of the target to be detected.

Here, with the target detection method provided by the embodiments of the present disclosure, for each frame of point cloud data, the scanning time information when the target to be determined is scanned by the radar apparatus may be determined. Thus, the scanning time difference information of the target to be detected in two frames of point cloud data may be determined based on the scanning time information. In the case that the displacement information of the target to be detected is determined, the moving speed information of the target to be detected may be obtained by calculating the ratio between the displacement information and the scanning time difference information using a speed calculation method. The moving speed information of the target to be detected includes a moving speed and/or a moving acceleration of the target to be detected.

In a process of determining the displacement information of the target to be detected, the position offset of the target to be detected in two frames of point cloud data may be determined based on the position information of the target to be detected in each of a plurality of frames of point cloud data, and the displacement information of the target to be detected may be determined by mapping the position offset into an actual scenario.

In addition, for each frame of point cloud data, the scanning time information when the target to be detected is scanned in the frame of point cloud data may be determined based on the scanning direction angle information when the target to be detected is scanned in the frame of point cloud data and the scanning start and end time information and the scanning start and end angle information corresponding to the frame of point cloud data.

The scanning start and end time information and the scanning start and end angle information may be recorded by a driver built in the radar apparatus. Theoretically speaking, the radar apparatus has rated operating frequency. The common operating frequency is 10 HZ. In this way, 10 frames of point cloud data may be output in 1 second. For each frame of point cloud data, a time difference between the scanning end time and the scanning start time may be 100 milliseconds. For a 360°-ring scanning apparatus, the start angle and the end angle for one frame of point cloud data are generally overlapped, i.e., the angle difference between the scanning end angle and the scanning start angle may be 360°.

However, in an actual operation process of the radar apparatus, due to mechanical wear, external resistance, data loss, etc., the time difference may be less than 100 milliseconds and the angle difference may be less than 360°. In order to ensure the accuracy of the scanning time information determined by the embodiments of the present disclosure, the scanning start and end time information and the scanning start and end angle information are recorded only by the drive built in the radar apparatus in real time, i.e., in the embodiments of the present disclosure, the actually measured values may be used, for example, the time difference may be 99 milliseconds, and the angle difference may be 359°.

Thus, the more accurate scanning time information may be obtained based on the actually measured values related to the scanning start and end information and the scanning direction information corresponding to the target to be detected. In each frame of point cloud data, a process of determining the scanning time information when the target to be detected is scanned may be implemented by the following operations.

At S1, for each frame of point cloud data, a first angle difference between a direction angle for the target to be detected and a scanning start angle is determined based on the scanning direction angle information when the target to be detected is scanned in the frame of point cloud data and the scanning start angle information in the scanning start and end angle information corresponding to the frame of point cloud data. A second angle difference between the scanning end angle and the scanning start angle is determined based on the scanning end angle information and the scanning start angle information in the scanning start and end angle information corresponding to the frame of point cloud data. The time difference between the scanning end time information and the scanning start time information is determined based on the scanning end time information when the scanning of the frame of point cloud data is ended in the scanning start and end time information corresponding to the frame of point cloud data and the scanning start time information when the scanning of the frame of point cloud data is started in the scanning start and end time information corresponding to the frame of point cloud data.

At S2, the scanning time information when the target to be detected is scanned in the frame of point cloud data based on the first angle difference, the second angle difference, the time difference, and the scanning start time information.

Here, when the scanning time information corresponding to the target to be detected is determined, the scanning duration from the scanning start time to the time when the target to be detected is scanned may be determined on the premise of determining the scanning start time information. Here, the scanning duration may be determined based on time difference and an angle difference proportion determined by calculating the ratio of the first angle difference to the second angle difference. Thus, the scanning time information of the target to be detected after the determined scanning duration elapses may be calculated based on the scanning start time.

Here, considering that a scanning process of the radar apparatus may be at a constant speed, the scanned angle may occupy a certain proportion of a complete rotation (corresponding to the angle difference between the scanning end angle and the scanning start angle). When it is determined that there is a target to be detected at a scanning position, the scanning time information corresponding to the target to be detected may be determined by using this proportional relationship.

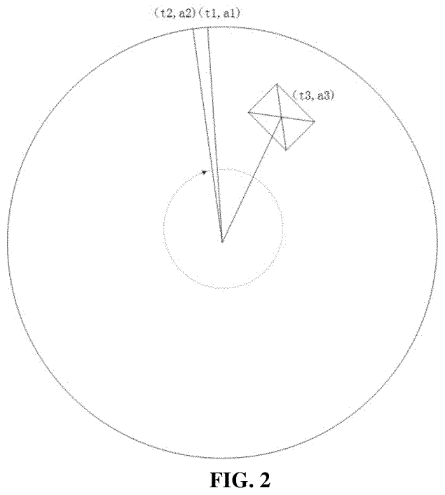

In order to facilitate understanding the process of determining the scanning time information, detailed description may be made with reference to FIG. 2.

As shown in FIG. 2, the radar apparatus scans from the scanning start position corresponding to (t₁, a₁) and in a clockwise direction here. After the position of the target to be detected corresponding to (t₃, a₃) is scanned, scanning is continued in the clockwise direction and is ended until the scanning end position corresponding to (t₂, a₂) is scanned. Here, t₃, t₂ and t₁ are respectively used to represent the scanning time information corresponding to the target to be detected, the scanning end time information, and the scanning start time information, and a₃, a₂ and a₁ are respectively used to represent the scanning direction angle information corresponding to the target to be detected, the scanning end angle information, and the scanning start angle information.

It is to be noted that, in the target detection method provided by the embodiments of the present disclosure, the target to be detected is required to be perceived from the point cloud data before determining the scanning time information. For example, for the point cloud data collected in real time, a point cloud block with the highest similarity to target point cloud may be found from the point cloud data based on a point cloud feature description vector, so as to determine the target to be detected. Generally speaking, representation methods, such as a 3-Dimensional (3D) box, a 2-Dimensional (2D) box, a polygon, etc. may be used. Specific representation methods are related to the adopted specific perception method, which is not specifically limited here.

No matter the target to be detected is determined by which method, the time when the geometric center of the target to be detected is scanned by laser is taken as a timestamp (corresponding to the scanning time information) of the target to be detected. Here, the target to be detected is abstracted as a geometric mass point in a lidar coordinate system.

If a preperception algorithm gives a 3D box, the center point of the 3D box may be used as the geometric center. If the preperception algorithm gives a 2D box on a top view, the center point of the 2D box may be used as the geometric center (as shown in FIG. 2). If the preperception algorithm gives a polygon on the top view, the average coordinates of polygon nodes may be used as the geometric center. Thus, an offset angle of a connecting line between the geometric center and an original point of a lidar coordinate system relative to the forward X axis may be determined based on the geometric center of the target to be detected, i.e., the scanning direction angle information a₃ corresponding to the target to be detected is determined.

It can be known from FIG. 2 that the a₂-a₁ is less than 360°, i.e., the actually measured angle difference is used here. Thus, the angle scanned by the radar apparatus will occupy a certain proportion of the overall scanning angle, which may be described by the following equation (1).

$$\frac{{a}_{3} - {a}_{1}}{{a}_{2} - {a}_{1}} = \frac{{t}_{3} - {t}_{1}}{{t}_{2} - {t}_{1}} \qquad ( 1 )$$

Here, a₃−a₁ is used to represent the first angle difference between the direction angle for the target to be detected and the scanning start angle, a₂−a₁ is used to represent the second angle difference between the scanning end angle and the scanning start angle, and t₂−t₁ is used to represent the time difference between the scanning end time information and the scanning start time information.

It can be known from the above formula that, in the case that the target to be detected is detected by the radar apparatus, the proportion of the scanned angle to the total angle is consistent with that of the scanned duration to the total duration. Thus, the abovementioned formula is transformed into the following expression (2) related to t₃, i.e.,

$${t}_{3} = \frac{{a}_{3} - {a}_{1}}{{a}_{2} - {a}_{1}} \cdot ( {t}_{2} - {t}_{1} ) + {t}_{1} \qquad ( 2 )$$

It can be seen that, in the target detection method provided by the embodiments of the present disclosure, the scanning time information when the target to be detected is scanned may be determined based on the first angle difference, the second angle difference, the time difference, and the scanning start time information.

When the scanning time information corresponding to the target to be detected is determined, first, the proportion of the angle difference corresponding to the target to be detected may be determined based on calculating the ratio of the first angle difference to the second angle difference, then, the proportion of the angle difference and the time difference may be multiplied to obtain the scanning duration from the scanning start time to the time when the target to be detected is scanned, and finally, the corresponding scanning time information can be obtained by summing the scanning time and the scanning start time information.

After the scanning time information is determined according to the abovementioned method, the moving speed information of the target to be detected is determined.

Considering the key role of the position information of the target to be detected in determining the moving information of the target to be detected, it can be described in detail next.

In the target detection method provided by the embodiments of the present disclosure, the position information of the target to be detected may be determined according to the following operations.

At S1, gridding processing is performed on each frame of point cloud data to obtain a grid matrix. The value of each element in the grid matrix is used to represent whether a point-cloud point exists in a grid corresponding to the element.

At S2, a sparse matrix corresponding to the target to be detected is generated according to the grid matrix and the size information of the target to be detected.

At S3, the position information of the target to be detected is determined based on the generated sparse matrix.

In the embodiments of the present disclosure, for each frame of point cloud data, gridding processing may be performed first, and then, sparse processing may be performed on the grid matrix obtained by the gridding processing, so as to generate the sparse matrix. The process of gridding processing here may refer to a process of mapping the spatially distributed point cloud data containing various point-cloud points into a set grid and performing grid coding (corresponding to a zero-one matrix) based on the point-cloud points corresponding to the grid. The process of sparse processing may be a process of performing a dilating processing operation (corresponding to a processing result of increasing elements indicated as 1 in the zero-one matrix) or an eroding processing operation (corresponding to a processing result of reducing elements indicated as 1 in the zero-one matrix) on the above-mentioned zero-one matrix based on the size information of the target to be detected in a target scenario. Next, the process of grating processing and the process of sparse processing are further described.

In the process of grating processing, the point-cloud points distributed in a Cartesian continuous real number coordinate system may be transformed into a gridded discrete coordinate system.

In order to facilitate understanding the process of gridding processing, detailed description may be made with reference to an example. In the example of the present disclosure, there are point-cloud points such as a point A (0.32 m, 0.48 m), a point B (0.6 m, 0.4801 m), a point C (2.1 m, 3.2 m), etc. Gridding is performed by taking 1 m as a grid width, the range from (0 m, 0 m) to (1 m, 1 m) corresponds to a first grid, the range from (0 m, 1 m) to (1 m, 2 m) corresponds to a second grid, and the like. The gridded A′ (0, 0) and B′ (0, 0) are both in the grid of a first row and a first column, and C′ (2, 3) may be in the grid of a second row and a third column, so as to realize the transformation from the Cartesian continuous real number coordinate system to the discrete coordinate system. The coordinate information relating to the point-cloud points may be determined with reference to a reference point (for example, the position of a radar device used for collecting the point cloud data), which is not elaborated here.

In the embodiments of the present disclosure, 2-Dimensional gridding may be performed, or 3-Dimensional gridding may also be performed. Height information is added in the 3-Dimensional gridding compared with the 2-Dimensional gridding. Next, detailed description will be made by taking the 2-Dimensional gridding as an example.

For the 2-Dimensional gridding, a finite space may be divided into n*m grids, and generally, may be divided at equal intervals. The interval size may be configured. At this time, gridded point cloud data may be coded by using the zero-one matrix (i.e., the abovementioned grid matrix). Each grid may be represented by coordinates composed of a unique row number and column number. If one or more point-cloud points exist in the grid, the grid is coded as 1, and otherwise, the grid is coded as 0, so as to obtain a coded zero-one matrix.

After the grid matrix is determined according to the abovementioned method, a sparse processing operation may be performed on the elements in the grid matrix according to the size information of the target to be detected, so as to generate a corresponding sparse matrix.

The size information related to the target to be detected may be acquired in advance. Here, the size information of the target to be detected may be determined in combination with the image data collected synchronously with the point cloud data, and the size information of the target to be detected may also be estimated roughly based on a specific application scenario of the target detection method provided by the embodiments of the present disclosure. For example, for the field of automatic driving, an object in front of a vehicle may be a vehicle, and the general size information of the object may be determined as 4 m×4 m. In addition, in the embodiments of the present disclosure, the size information of the target to be detected may also be determined based on other manners, which is not specifically limited in the embodiments of the present disclosure.

In the embodiments of the present disclosure, the related sparse processing operation may include performing at least one dilating processing operation on a target element (i.e., represents an element that one or more point-cloud points exist in a grid corresponding to the element) in the grid matrix. The dilating processing operation here may be performed in the case that the size of a coordinate range of the grid matrix is smaller than the size of the target to be detected in a target scenario. That is, the range of the elements representing that one or more point-cloud points exist in the respective grids may be dilated step by step by performing the dilating processing operation one or more times, so that the dilated element range is matched with the target to be detected, to realize position determination. In addition, the sparse processing operation in the embodiments of the present disclosure may also include performing at least one eroding processing operation on the target element in the grid matrix. The eroding processing operation here may be performed in the case that the size of the coordinate range of the grid matrix is greater than the size of the target to be detected in the target scenario. That is, the range of the elements representing that one or more point-cloud points exist in the respective grids may be reduced step by step by performing the eroding processing operation one or more times, so that the reduced element range is matched with the target to be detected, to realize position determination.

In specific application, whether to perform one dilating processing operation, or a plurality of dilating processing operations, or one eroding processing operation, or a plurality of eroding processing operations depends on whether a difference value between the size of the coordinate range of the sparse matrix obtained by performing at least one shift processing and at least one logical operation processing and the size of the target to be detected in the target scenario is within a pre-set threshold range, i.e., the dilating or eroding processing operation adopted by the present disclosure is performed based on the constraints of the size information of the target to be detected, so that the information represented by the determined sparse matrix is more consistent with the information related to the target to be detected.

It can be understood that the purpose of the sparse processing realized based on the dilating processing operation or the eroding processing operation is to enable the generated sparse matrix to represent more accurate information related to the target to be detected.

In the embodiments of the present disclosure, the dilating processing operation may be implemented based on a shift operation and a logical OR operation, or may also be implemented based on performing convolution after negation and performing negation after convolution. Specific methods adopted by the two operations are different, but the effects of the finally generated sparse matrices may be consistent.

In addition, the eroding processing operation may be implemented based on the shift operation and the logical OR operation, or may also be implemented directly based on a convolution operation. Similarly, specific methods adopted by the two operations are different, but the effects of the finally generated sparse matrices may also be consistent.

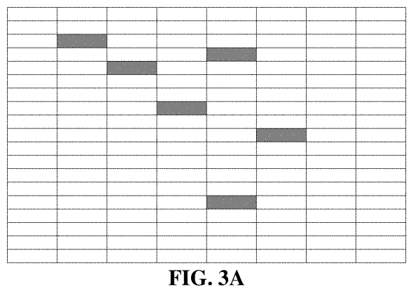

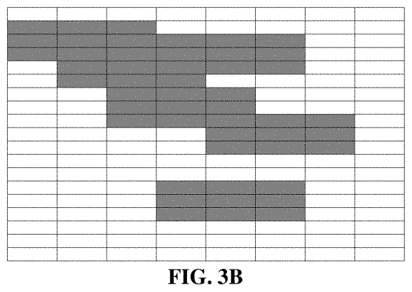

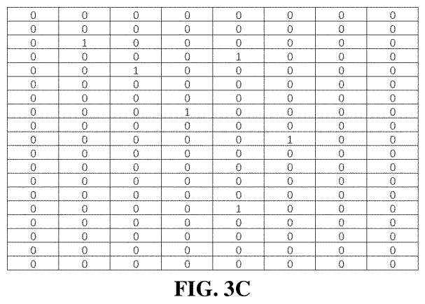

Next, taking the dilating processing operation as an example, a generation process of the abovementioned sparse matrix is further described in combination with the specific example diagrams of generating the sparse matrix shown in FIG. 3A to FIG. 3B.

As shown in FIG. 3A which is a schematic diagram of the grid matrix (corresponding to an uncoded grid matrix) obtained after gridding processing, an eight-neighbor dilating operation is performed on each target element (corresponding to a grid having a filling effect) in the grid matrix, to obtain a corresponding sparse matrix, as shown in FIG. 3B. It can be known that, in the embodiments of the present disclosure, the eight-neighborhood dilating operation is performed on the target element having a point-cloud point at a corresponding grid in FIG. 3A, so that each target element becomes an element set after dilating, and the grid width corresponding to the element set may be matched with the size of the target to be detected.

The eight-neighborhood dilating operation may be a process of determining other elements related to the target element, where the absolute value of the difference between the abscissa or ordinate value of other elements and the abscissa or ordinate value of the target element does not exceed 1. Except for the elements at the edge of the grid, there are generally eight elements (corresponding to the abovementioned element set) in a neighborhood of one element. The input for a dilating processing result may be the coordinate information of six target elements, and the output for the dilating processing result may be the coordinate information of the element set in eight neighborhoods of the target element, as shown in FIG. 3B.

It is to be noted that, in actual application, a four-neighborhood dilating operation or other dilating operations may also be performed in addition to the eight-neighborhood dilating operation, which is not specifically limited here. In addition, in the embodiments of the present disclosure may also perform a plurality of dilating operations. For example, the dilating operation is performed again based on a dilating result shown in FIG. 3B, so as to obtain a sparse matrix with a larger element set range, which is not elaborated here.

In the embodiments of the present disclosure, the position information of the target to be detected may be determined based on the generated sparse matrix. In the embodiments of the present disclosure, it can be specifically implemented in two aspects as follows.

In a first aspect: the position information of the target to be detected may be determined based on a corresponding relationship between elements in the grid matrix and the coordinate range information of point-cloud points, which may be implemented specifically by the following operations.

At S1, coordinate information corresponding to each target element in the generated sparse matrix is determined based on the corresponding relationships between elements in the grid matrix and coordinate range information of point-cloud points.

At S2, the position information of the target to be detected is determined by combining the coordinate information corresponding to all target elements in the sparse matrix.

Here, it can be known based on related description of the abovementioned relevant gridding processing that each target element in the grid matrix may correspond to a plurality of point-cloud points. Thus, the coordinate range information corresponding to a plurality of point-cloud points and related elements may be determined in advance. Here, still taking a grid matrix with the dimension of N*M as an example, the target element with a point-cloud point may correspond to P point-cloud points. The coordinates of each point are (Xi, Yi), i belongs to 0 to P−1, Xi, Yi represents the position of the point-cloud point in the grid matrix, 0<=Xi<N, and 0<=Yi<M.

Thus, after the sparse matrix is generated, the coordinate information corresponding to each target element in the sparse matrix may be determined based on the corresponding relationships between abovementioned elements and the coordinate range information of point-cloud points that are determined in advance, i.e., an anti-gridding processing operation is performed.

It is to be noted that the sparse matrix is obtained based on performing the sparse processing on the elements, each representing that a point-cloud point exists in the grid corresponding to the element, in the grid matrix. Therefore, a target element in the sparse matrix may represent an element that a point-cloud point exists in the grid corresponding to the element.

In order to facilitate understanding the anti-gridding processing operation, detailed description may be made with reference to an example. Here, for example, the point A′ (0, 0) and the point B′ (0, 0) indicated by the sparse matrix is in the grid of a first row and a first column, and the point C′ (2, 3) is in the grid of a second row and a third column, in a process of performing the anti-gridding processing, for a first grid (0, 0), (0.5 m, 0.5 m) may be obtained by mapping the center of the first grid (0, 0) back to a Cartesian coordinate system, for a grid (2, 3) of the second row and the third column, (2.5 m, 3.5 m) may be obtained by mapping the center of the grid (2, 3) of the second row and the third column back to the Cartesian coordinate system, i.e., (0.5 m, 0.5 m) and (2.5 m, 3.5 m) may be determined as mapped coordinate information. Thus, the position information of the target to be detected may be determined by combining the mapped coordinate information.

In the embodiments of the present disclosure, the determination of the position information of the target to be detected can not only be implemented based on an approximation relationship of the sparse matrix with the target detection result, but also be implemented based on a trained convolutional neural network.

In a second aspect: in the embodiments of the present disclosure, at least one convolution processing may be performed on the generated sparse matrix based on a trained convolutional neural network first, and then the position information of the target to be detected may be determined based on a convolution result obtained by the convolution processing.

In a related technology of realizing target detection by using the convolutional neural network, it is required to traverse all input data to find neighborhood points of an input point successively to perform a convolution operation, and finally a set of all neighborhood points is output. However, in the target detection method provided by the embodiments of the present disclosure, it is only required to find the position where an effective point (namely, an element of 1 in a zero-one matrix) is located by rapidly traversing the target elements in the sparse matrix to perform the convolution operation, thereby greatly accelerating a calculation process of the convolutional neural network and improving the efficiency of determining the position information of the target to be detected.

Considering the key role of the sparse processing operation on the target detection method provided by the embodiments of the present disclosure, it can be described in the two aspects as follows.

In a first aspect: in the case that the sparse processing operation is a dilating processing operation, the embodiments of the present disclosure may be implemented in combination with shift processing and a logical operation, and may also be implemented based on performing convolution after negation and performing negation again after convolution.

First, in the embodiments of the present disclosure, one or more dilating processing operations may be performed based on at least one shift processing and at least one logical OR operation. In a specific implementation process, the number of times for performing dilating processing operations may be determined in combination with the size information of the target to be detected in the target scenario.

Here, for the first dilating processing operation, shift processing in a plurality of preset directions may be performed on a target element representing that a point-cloud point exists in a grid corresponding to the target element, so as to obtain a plurality of respective shifted grid matrices, and then the logical OR operation may be performed on the grid matrix and the plurality of shifted grid matrices corresponding to the first dilating processing operation, so that a sparse matrix after the first dilating processing operation may be obtained. Here, whether the size of a coordinate range of the obtained sparse matrix is less than the size of the target to be detected, and whether a corresponding difference value is large enough (for example, greater than a preset threshold value) may be determined. If yes, the shift processing in the plurality of preset directions and the logical OR operation may be performed on the target element in the sparse matrix obtained after the first dilating processing operation according to the abovementioned method, so as to obtain the sparse matrix after a second dilating processing operation, and in this way, until in the case that the difference value between the size of the coordinate range of a newly obtained sparse matrix and the size of the target to be detected in the target scenario belongs to a preset threshold range, the sparse matrix is determined.

It is to be noted that the sparse matrix obtained after any dilating processing operation is essentially a zero-one matrix. With the increase of the number of times for performing the dilating processing operations, the number of the target elements, each representing that a point-cloud point exists in the grid corresponding to the target element, in the obtained sparse matrix is also increased. Since the grid mapped by the zero-one matrix has width information, here, whether the size of the target to be detected in the target scenario is reached may be verified by using the size of the coordinate range corresponding to target elements in the sparse matrix, so that the accuracy of subsequent target detection application is improved.

The abovementioned logical OR operation may be implemented according to the following operations.

At S1, one shifted grid matrix is selected from a plurality of shifted grid matrices.

At S2, the logical OR operation is performed on the grid matrix before the current dilating processing operation and the selected shifted grid matrix to obtain an operation result.

At S3, a grid matrix that does not participate in the operation is circularly selected from a plurality of shifted grid matrices, and the logical OR operation is performed on the selected grid matrix and the last operation result until all the grid matrices are selected, so as to obtain a sparse matrix after the current dilating processing operation.

Here, a shifted grid matrix may be selected from a plurality of shifted grid matrices first, thus, the logical OR operation may be performed on the grid matrix before the current dilating processing operation and the selected shifted grid matrix to obtain the operation result. Here, the grid matrix that does not participate in the operation may be circularly selected from the plurality of shifted grid matrices and used to participate in the logical OR operation until all the grid matrices are selected, so as to obtain the sparse matrix after the current dilating processing operation.

In the embodiments of the present disclosure, the dilating processing operation may be four-neighborhood dilating taking a target element as a center, may also be eight-neighborhood dilating taking the target element as the center, or may also be other neighborhood processing operation manners. In a specific application, a neighborhood processing operation manner may be selected based on the size information of the target to be detected, which is not limited specifically here.

It is to be noted that, for different neighborhood processing operation modes, the preset directions for the respective shift processing are different. Taking four-neighborhood dilating as an example, shift processing may be performed on the grid matrix in four preset directions respectively, i.e. left shift, right shift, up shift, and down shift. Taking eight-neighborhood dilating as an example, shift processing may be performed on the grid matrix in eight preset directions respectively, i.e. left shift, right shift, up shift, down shift, up shift after left shift, down shift after left shift, up shift after right shift and down shift after right shift. In addition, in order to adapt to a subsequent logical OR operation, a logical OR operation may be performed firstly after a shifted grid matrix is determined based on a plurality of shifting directions, then a shift operation in the plurality of shift directions is performed on the result of the logical OR operation, a next logical OR operation is performed, and so on, until a sparse matrix after dilating processing is obtained.

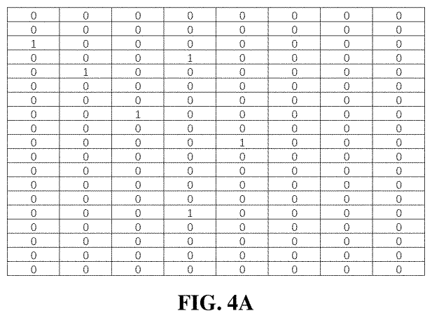

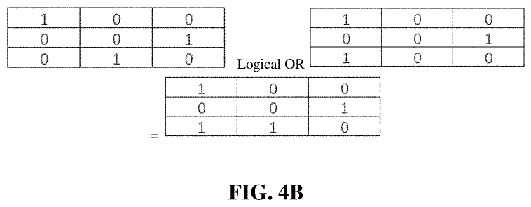

In order to facilitating understanding the abovementioned dilating processing operation, the grid matrix before coding shown in FIG. 3A may be transformed into the grid matrix after coding shown in FIG. 3C, and then the first dilating processing operation may be illustrated in combination with FIG. 4A to FIG. 4B.

The grid matrix as shown in FIG. 3C is a zero-one matrix, all positions of 1 in the matrix may represent the grids where the target element is located, and all 0 in the matrix may represent a background.

In the embodiments of the present disclosure, firstly, the neighborhood of all elements with the element values of 1 in the zero-one matrix may be determined by using a matrix shift. Here, the shift processing in four preset directions, i.e. left shift, right shift, up shift and down shift may be defined. The left shift is that column coordinates corresponding to all elements with the element values of 1 in a zero-one matrix minus one, as shown in FIG. 4A. The right shift is that column coordinates corresponding to all elements with the element values of 1 in a zero-one matrix plus one. The up shift is that raw coordinates corresponding to all elements with the element values of 1 in a zero-one matrix minus one. The down shift is that raw coordinates corresponding to all elements with the element values of 1 in a zero-one matrix plus one.

Secondly, in the embodiments of the present disclosure, the results of all neighborhoods may be merged by using a matrix logical matrix OR operation. For Matrix logical OR, in the case that two sets of zero-one matrix inputs with the same size are received, logical OR operation is performed on element values (zero or one) at the same position of two sets of matrices in sequence, and the obtained results form a new zero-one matrix as an output. FIG. 4B shows a specific example of a logical OR operation.

In a specific process of realizing logical OR, a left shifted grid matrix, a right shifted grid matrix, an up shifted grid matrix, and a down shifted grid matrix may be sequentially selected to participate in the operation of the logical OR. For example, the logical OR may be performed on the grid matrix and the left shifted grid matrix first to obtain a first operation result, the logical OR may be performed on the first operation result and the right shifted grid matrix to obtain a second operation result, the logical OR may be performed on the second operation result and the up shifted grid matrix to obtain a third operation result, and then the logical OR may be performed on the third operation result and the down shifted grid matrix, so as to obtain a sparse matrix after the first dilating processing operation.

It is to be noted that the abovementioned selection order related to a shifted grid matrix is only a specific example. In actual application, it can also be selected in combination with other manners. Considering the symmetry of a shifting operation, a logical OR operation may be performed after the up shift and the down shift are selected and paired, and a logical operation may be performed after the left shift and the right shift are paired. Two logical OR operations may be performed synchronously, which shortens the calculation time.

Second, in the embodiments of the present disclosure, the dilating processing operation may be realized in combination with convolution and twice negation processing, which may be specifically implemented by the following operations.

At S1, a first negation operation is performed on the elements in the grid matrix before the current dilating processing operation, so as to obtain a grid matrix after the first negation operation.

At S2, at least one convolution operation is performed on the grid matrix after the first negation operation based on a first preset convolution kernel, so as to obtain the grid matrix with preset sparsity after the at least one convolution operation performed. The preset sparsity is determined by the size information of the target to be detected in a target scenario.

At S3, a second negation operation is performed on the elements in the grid matrix with the preset sparsity after the at least one convolution operation.

In the embodiments of the present disclosure, the dilating processing operation may be realized by performing convolution after negation and performing negation again after convolution. The obtained sparse matrix may also represent information related to the target to be detected to a certain extent. In addition, considering that the abovementioned convolution operation may be automatically combined with the convolutional neural network used in performing a subsequent application, such as target detection, the detection efficiency can be improved to a certain extent.

In the embodiments of the present disclosure, the negation operation may be implemented based on the convolution operation, and may also be implemented based on other convolution operation manners. In order to facilitate cooperation with subsequent application networks (such as a convolutional neural network for the target detection), herein, the negation operation may be implemented specifically using the convolution operation. Next, the first negation operation will be described in detail.

Here, the convolution operation may be performed on other elements, other than the target element, in the grid matrix before the current dilating processing operation based on a second preset convolution kernel, so as to obtain first negated elements. The convolution operation may also be performed on the target elements in the grid matrix before the current dilating processing operation based on the second preset convolution kernel, so as to obtain second negated elements. The grid matrix after the first negation operation may be determined based on the first negated elements and second negated elements.

An implementation process related to the second negation operation may refer to an implementation process of the first negation operation, which will not be elaborated here.

In the embodiment of the present disclosure, the at least one convolution operation may be performed on the grid matrix after the first negation operation by using a first preset convolution kernel, so as to obtain a grid matrix with preset sparsity. If the dilating processing operation may be used as a means to expand the number of the target elements in the grid matrix, then the abovementioned convolution operation may be regarded as a process to reduce the number of the target elements in the grid matrix (corresponding to the eroding processing operation). Since the convolution operation in the embodiment of the present disclosure is performed on the grid matrix after the first negation operation, an equivalent operation equivalent to the abovementioned dilating processing operation is realized by combining the negation operation and the eroding processing operation, and then performing the negation operation again.

For the first convolution operation, the convolution operation is performed on the grid matrix after the first negated operation and the first preset convolution kernel, so as to obtain a grid matrix after the first convolution operation. After it is determined that the sparsity of the grid matrix after the first convolution operation does not reach a preset sparsity, the convolution operation may be performed on the grid matrix after the first convolution operation and the first preset convolution kernel again, so as to obtain a matrix grid after a second convolution operation, and so on, until a grid matrix with preset sparsity is determined.

The sparsity may be determined based on the proportion distribution of target elements and non-target elements in the grid matrix. The more the proportion of target elements is, the larger the size information of the target to be detected correspondingly represented by the target elements. On the contrary, the less the proportion of target elements is, the smaller the size information of the target to be detected correspondingly represented by the target elements. In the embodiment of the present disclosure, the convolution operation may be stopped when the proportion distribution reaches the preset sparsity.

In the embodiments of the present disclosure, the convolution operation may be performed for one or more times. Here, the specific operation process of the first convolution operation may be described, and includes the following operations.

At S1, for the first convolution operation, all grid sub-matrixes are selected from the grid matrix after the first negation operation according to the size of the first preset convolution kernel and a preset step size.

At S2, for each grid sub-matrix which is selected, the grid sub-matrix and a weight matrix are multiplied to obtain a first operation result, and an addition operation is performed on the first operation result and an offset to obtain a second operation result.

At S3, the grid matrix after the first convolution operation is determined based on the second operation results corresponding to all grid sub-matrixes.

Here, the grid matrix after the first negation operation may be traversed by a traversing manner. For each grid sub-matrix which is traversed, the grid sub-matrix and the weight matrix may be multiplied, so as to obtain the first operation result. The addition operation may be performed on the first operation result and the offset, so as to obtain the second operation result. Thus, the second operation results corresponding to various grid sub-matrices are combined into the respective matrix elements, so that the grid matrix after the first convolution operation may be obtained.

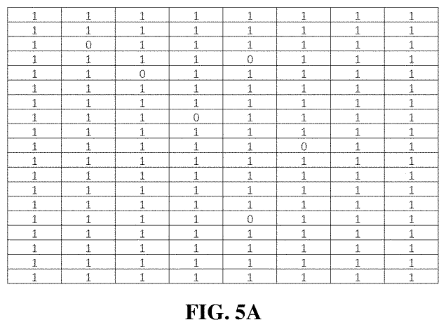

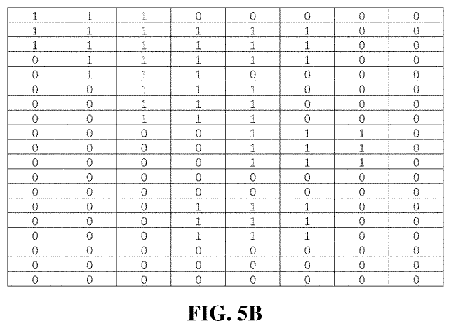

In order to facilitating the understanding of the abovementioned dilating processing operation, the dilating processing operation is still illustrated in combination with FIG. 5A to FIG. 5B by taking the coded grid matrix shown in FIG. 3C as an example.

Here, the first negation operation may be implemented by using a 1*1 convolution kernel (i.e., the second preset convolution kernel). The weight value of the second convolution kernel is −1, the offset is 1, at this time, the weight value and the offset are substituted into a convolution formula of {output=input grid matrix*weight+offset}. If the input is a target element having a value of 1 in the grid matrix, then the output=1*−1+1=0. If the input is a non-target element having a value of 0 in the grid matrix, then the output=0*−1+1=1. Thus, after the 1*1 convolution kernel acts on the input, the zero-one matrix may be negated, the element value 0 becomes 1, the element value 1 becomes 0, as shown in FIG. 5A.

In actual application, the eroding processing operation may be implemented by using a 3*3 convolution kernel (i.e., the first preset convolution kernel) and a Rectified Linear Unit (ReLU). Each weight value included in a weight value matrix of the first preset convolution kernel is 1 and the offset is 8, so that the eroding processing operation may be implemented by using a formula {output=ReLU (inputted grid matrix after first negation operation*weight+offset)}.

Here, only in the case that all elements in the inputted 3*3 grid sub-matrix are 1, output=ReLU (9−8)=1. Otherwise, Output=ReLU (inputted grid matrix*1−8)=0, herein, the (inputted grid matrix*1−8)<0, the grid matrix after the convolution operation is shown in FIG. 5B.

Here, an eroding operation may be superimposed once when a layer of convolutional network with the second preset convolution kernel is nested very time, so that the grid matrix with fixed sparsity may be obtained. A second negation operation may be equivalent to one dilating processing operation, so that the generation of the sparse matrix may be realized.

In a second aspect: in the case that the sparse processing operation is an eroding processing operation, the embodiment of the present disclosure may be implemented in combination with shift processing and a logical operation, or may also be implemented based on the convolution operation.

First, in the embodiment of the present disclosure, the eroding processing operation may be performed one or more times based on performing the shift processing and a logical AND operation for at least one time. In a specific implementation process, a specific number of times for performing the eroding processing operations may be determined in combination with the size information of the target to be detected in the target scenario.

Similar to implementing the dilating processing based on the shift processing and the logical OR operation in the first aspect, in a process of performing an eroding processing operation, the shift processing may be performed on the grid matrix firstly. Different from the abovementioned dilating processing, the logical operation here may be the logical AND operation for the shifted grid matrix. With respect to the process of implementing the eroding processing operation based on the shift processing and the logical AND operation, specific reference is made to the abovementioned description and will not be elaborated here.

In a similar way, in the embodiment of the present disclosure, the eroding processing operation may be four-neighborhood erosion taking a target element as a center, may also be eight-neighborhood dilating taking the target element as the center, or may also be other neighborhood processing operation manners. In a specific application, a respective neighborhood processing operation manner may be selected based on the size information of the target to be detected, which is not limited specifically here.

Second, in the embodiment of the present disclosure, the eroding processing operation may be realized in combination with convolution processing, which may be specifically implemented by the following operations.

At S1, at least one convolution operation is performed on a grid matrix based on a third preset convolution kernel, so as to obtain the grid matrix with preset sparsity after the at least one convolution operation. The preset sparsity is determined by the size information of the target to be detected in a target scenario.

At S2, the grid matrix with the preset sparsity after the at least one convolution operation is determined as a sparse matrix corresponding to the target to be detected.

The convolution operation may be regarded as a process of reducing the number of target elements in the grid matrix, i.e., an eroding processing process. For the first convolution operation, the convolution operation is performed on the grid matrix and the first preset convolution kernel, so as to obtain a grid matrix after the first convolution operation. After it is determined that the sparsity of the grid matrix after the first convolution operation does not reach a preset sparsity, the convolution operation may be performed on the grid matrix after the first convolution operation and the third preset convolution kernel again, so as to obtain a matrix grid after a second convolution operation, and so on, until a grid matrix with preset sparsity is determined, so as to obtain the sparse matrix corresponding to the target to be detected.

The convolution operation in the embodiment of the present embodiment may be performed for one or more times. With regard to a specific process of the convolution operation, reference is made to the related description for implementing the dilating processing based on the convolution and negation in the first aspect, and will not be elaborated here.

It is to be noted that, in specific application, the generation of the sparse matrix may be implemented by using convolutional neural networks with different data processing bit widths. For example, 4 bits may be used to represent the input and the output parameters of the network and parameters used in calculation, such as, element values (0 or 1) of the grid matrix, the weight value, the offset, etc. In addition, 8 bits may also be used to represent, so as to adapt to the network processing bit width and improve the operation efficiency.

In a specific application of the target detection method provided by the embodiment of the embodiment of the present disclosure, the radar apparatus may be arranged on intelligent devices, such as an intelligent vehicle, an intelligent lamp post, and a robot. In the case that the same target is detected in two adjacent frames of point cloud data scanned by the radar apparatus, if the same target displaces L relatively, the time when the target appears in the first frame is t1, and the time when the target appears in the second frame is t2, then t2−t1 is equal to a fixed interval T between two frames in a related technology, thus, the speed of the target is L/T. The t2−t1 determined by the method provided by the embodiments of the present disclosure reflects a time interval when a real target is scanned, the range is between [0, 2T], and the target speed determined by using the real scanning time interval is also more accurate.

It can be known from the speed determination formula that the higher the speed is, the larger the corresponding relative displacement is. If the speed of the target cannot be determined very accurately, then the intelligent device may not cope well with the changes caused by relative displacement. In order to solve such a problem, the embodiments of the present disclosure provide a method for accurately determining scanning time information of a target. Thus, more accurate speed estimation may be brought, and the intelligent device is controlled to make a more reasonable determination in combination with the speed information of the intelligent device itself, for example, whether an emergency brake is required, whether an overtaking is possible, etc.

In a multi-target tracking algorithm, each detection target in the current frame of point cloud data are matched with all trajectories of historical frames to acquire a matching similarity, so as to determine which trajectory in the history the detection target belongs to. During matching, because the target may be moving, moving compensation may be performed on a historical trajectory. A compensation manner may be based on the position and speed of the target in the historical trajectory, and then the position of a target in the current frame may be predicted. Here, the accurate timestamp will make the determined speed more accurate, and then the predicted position of the target in the current frame more accurate. Thus, even if multi-target tracking is performed, the tracking based on an accurate predicted position will greatly reduce the failure rate of target tracking.

In addition, the target detection method provided by the embodiment of the present disclosure may also be used to predict a movement trajectory of the target to be detected in a future time period based on moving speed information and historical movement trajectory information of the target to be detected. In a specific application, the trajectory prediction may also be implemented by using a machine learning method or other trajectory prediction methods. For example, the moving speed information and the historical movement trajectory information of the target to be detected may be input into a trained neural network, so as to obtain the predicted movement trajectory in the future time period.

With the target detection method, a moving track point of a target to be detected in a scanning process of an radar apparatus may be determined based on position information of the target to be detected in each frame of the point cloud data, more accurate scanning direction angle information may be determined by taking interrelated offset information among various moving track points as a reference, and more accurate moving information (for example, moving speed information) of the target to be detected may be obtained in combination with the time information of each frame of point cloud data.

It can be understood by those skilled in the art that, in the above-mentioned method of the specific implementation manners, the writing sequence of each step does not mean a strict execution sequence and is not intended to form any limitation to the implementation process and a specific execution sequence of each step should be determined by functions and probable internal logic thereof.

Based on the same inventive conception, the embodiments of the present disclosure further provide a target detection apparatus corresponding to the target detection method. The principle of the apparatus in the embodiments of the present disclosure for solving the problem is similar to the abovementioned target detection method of the embodiments of the present disclosure, so implementation of the apparatus may refer to implementation of the method. Repeated parts will not be elaborated.

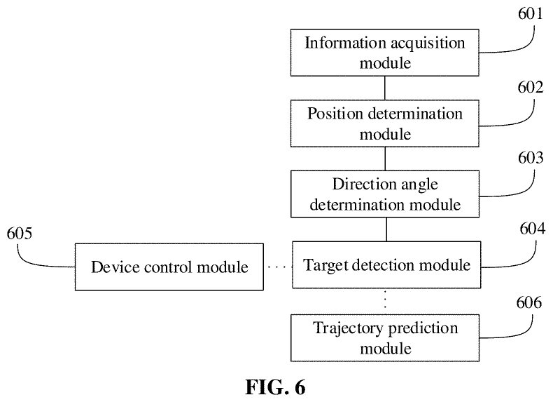

Referring to FIG. 6, which is a schematic structural diagram of a target detection apparatus provided by the embodiment of the present disclosure. The apparatus includes: an information acquisition module 601, a position determination module 602, a detection angle determination module 603, and a target detection module 604.

The information acquisition module 601 is configured to acquire a plurality of frames of point cloud data obtained through scanning by a radar apparatus and time information of each frame of point cloud data obtained through scanning.

The position determination module 602 is configured to determine position information of a target to be detected based on each frame of point cloud data.

The direction angle determination module 603 is configured to determine scanning direction angle information when the target to be detected is scanned by the radar apparatus in each frame of point cloud data based on the position information of the target to be detected in each frame of point cloud data.

The target detection module 604 is configured to determine moving information of the target to be detected according to the position information of the target to be detected in each frame of point cloud data, the scanning direction angle information when the target to be detected is scanned by the radar apparatus in each frame of point cloud data, and the time information of each frame of point cloud data obtained through scanning.

In an implementation, the target detection module 604 is configured to determine the moving information of the target to be detected according to the following operations.

The moving information of the target to be detected is determined according to the position information of the target to be detected in each frame of point cloud data, the scanning direction angle information when the target to be detected is scanned by the radar apparatus in each frame of point cloud data, and scanning start and end time information and scanning start and end angle information corresponding to each frame of point cloud data.

In an implementation, the target detection module 604 is configured to determine the moving information of the target to be detected according to the following operations.

For each frame of point cloud data, the scanning time information when the target to be detected is scanned in the frame of point cloud data is determined based on the scanning direction angle information when the target to be detected is scanned in the frame of point cloud data and the scanning start and end time information and the scanning start and end angle information corresponding to the frame of point cloud data.

Displacement information of the target to be detected is determined based on position information of the target to be detected in the plurality of frames of point cloud data.

Moving speed information of the target to be detected is determined based on the scanning time information when the target to be detected is scanned respectively in the plurality of frames of point cloud data and the displacement information of the target to be detected.

In an implementation, the target detection module 604 is configured to determine the scanning time information when the target to be detected is scanned in the frame of point cloud data according to the following operations.

For each frame of point cloud data, a first angle difference between a direction angle for the target to be detected and a scanning start angle is determined based on the scanning direction angle information when the target to be detected is scanned in the frame of point cloud data and the scanning start angle information in the scanning start and end angle information corresponding to the frame of point cloud data.

A second angle difference between a scanning end angle and a scanning start angle is determined based on scanning end angle information and the scanning start angle information in the scanning start and end angle information corresponding to the frame of point cloud data.

The time difference between the scanning end time information and the scanning start time information is determined based on the scanning end time information when the scanning of the frame of point cloud data is ended in the scanning start and end time information corresponding to the frame of point cloud data and the scanning start time information when the scanning of the frame of point cloud data is started in the scanning start and end time information corresponding to the frame of point cloud data.

The scanning time information when the target to be detected is scanned in the frame of point cloud data is determined based on the first angle difference, the second angle difference, the time difference, and the scanning start time information.

In an implementation, the apparatus further includes a device control module 605.

The device control module 605 is configured to control, based on the moving speed information of the target to be detected and the speed information of an intelligent device provided with a radar apparatus, the intelligent device.

In an implementation, the apparatus further includes a trajectory prediction module 606.

The trajectory prediction module 606 is configured to predict a movement trajectory of the target to be detected in a future time period based on the moving speed information and historical movement trajectory information of the target to be detected.

In an implementation, the position determination module 602 is configured to determine the position information of the target to be detected based on each frame of point cloud data according to the following operations.

Gridding processing is performed on each frame of point cloud data to obtain a grid matrix. A value of each element in the grid matrix is used to represent whether a point-cloud point exists in a grid corresponding to the element.

A sparse matrix corresponding to the target to be detected is generated according to the grid matrix and size information of the target to be detected.

The position information of the target to be detected is determined based on the generated sparse matrix.

In an implementation, the position determination module 602 is configured to generate the sparse matrix corresponding to the target to be detected based on the grid matrix and the size information of the target to be detected according to the following operations.

At least one dilating processing operation or at least one eroding processing operation is performed on one or more target elements in the grid matrix according to the grid matrix and the size information of the target to be detected, to generate the sparse matrix corresponding to the target to be detected.

The target element represents an element that a point-cloud point exists in a grid corresponding to the element.

In an implementation, the position determination module 602 is configured to generate the sparse matrix corresponding to the target to be detected according to the following operations.

At least one shift processing and at least one logical operation processing are performed on the one or more target elements in the grid matrix to obtain the sparse matrix corresponding to the target to be detected. A difference value between a size of a coordinate range of the obtained sparse matrix and the size of the target to be detected is within a pre-set threshold range.

In an implementation, the position determination module 602 is configured to generate the sparse matrix corresponding to the target to be detected according to the following operations.

A first negation operation is performed on elements in the grid matrix before a current dilating processing operation, to obtain a grid matrix after the first negation operation.

At least one convolution operation is performed on the grid matrix after the first negation operation based on a first preset convolution kernel, so as to obtain a grid matrix with preset sparsity after the at least one convolution operation. The preset sparsity is determined by the size information of the target to be detected.

A second negation operation is performed on elements in the grid matrix with the preset sparsity after the at least one convolution operation, to obtain the sparse matrix.

In an implementation, the position determination module 602 is configured to perform a first negation operation on the elements in the grid matrix before the current dilating processing operation to obtain the grid matrix after the first negation operation according to the following operations.

A convolution operation is performed on other elements, other than the one or more target elements, in the grid matrix before the current dilating processing operation based on a second preset convolution kernel, to obtain one or more first negated elements. A convolution operation is performed on the one or more target elements in the grid matrix before the current dilating processing operation based on the second preset convolution kernel, to obtain one or more second negated elements.

The grid matrix after the first negation operation is obtained based on the one or more first negated elements and the one or more second negated elements.

In an implementation, the position determination module 602 is configured to perform the at least one convolution operation on the grid matrix after the first negation operation based on the first preset convolution kernel to obtain the grid matrix with the preset sparsity after the at least one convolution operation according to the following operations.

For a first convolution operation, a convolution operation is performed on the grid matrix after the first negation operation and the first preset convolution kernel, to obtain a grid matrix after the first convolution operation.

Whether sparsity of the grid matrix after the first convolution operation reaches the preset sparsity is determined.

If not, the operation of performing the convolution operation on a grid matrix after a last convolution operation and the first preset convolution kernel to obtain the grid matrix after a current convolution operation is executed repeatedly, until the grid matrix with the preset sparsity after the at least one convolution operation is obtained.

In an implementation, the first preset convolution kernel has a weight matrix and an offset corresponding to the weight matrix. The position determination module 602 is configured to perform, for the first convolution operation, the convolution operation on the grid matrix after the first negation operation and the first preset convolution kernel, to obtain the grid matrix after the first convolution operation according to the following operations.

For the first convolution operation, all grid sub-matrixes are selected from the grid matrix after the first negation operation according to a size of the first preset convolution kernel and a preset step size.

For each grid sub-matrix which is selected, the grid sub-matrix and a weight matrix are multiplied to obtain a first operation result, and an addition operation is performed the first operation result and the offset to obtain a second operation result.

The grid matrix after the first convolution operation is determined based on second operation results corresponding to all the grid sub-matrixes.

In an implementation, the position determination module 602 is configured to perform the at least one eroding processing operation on the one or more elements in the grid matrix based on the grid matrix and the size information of the target to be detected, to generate a sparse matrix corresponding to the target to be detected according to the following operations.

At least one convolution operation is performed on the grid matrix to be processed based on a third preset convolution kernel, to obtain a grid matrix with preset sparsity after the at least one convolution operation. The preset sparsity is determined by the size information of the target to be detected.

The grid matrix with the preset sparsity after the at least one convolution operation is determined as the sparse matrix corresponding to the target to be detected.

In an implementation, the position determination module 602 is configured to determine the position information of the target to be detected based on the generated sparse matrix according to the following steps.

Gridding processing is performed on each frame of point cloud data, to obtain a grid matrix and corresponding relationships between elements in the grid matrix and coordinate range information of point-cloud points.

Coordinate information corresponding to each target element in the generated sparse matrix is determined based on the corresponding relationships between elements in the grid matrix and coordinate range information of point-cloud points.

The position information of the target to be detected is determined by combining coordinate information corresponding to all target elements in the sparse matrix.

In an implementation, the position determination module 602 is configured to determine the position information of the target to be detected based on the generated sparse matrix according to the following operations.

At least one convolution processing is performed on each target element in the generated sparse matrix based on a trained convolutional neural network, to obtain a convolution result.

The position information of the target to be detected is determined based on the convolution result.

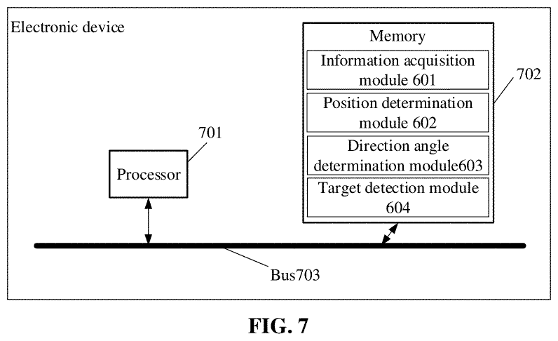

The embodiments of the present disclosure further provide an electronic device. As shown in FIG. 7 which is a schematic structural diagram of the electronic device provided by the embodiments of the present disclosure, the electronic device includes a processor 701, a memory 702, and a bus 703. The memory 702 stores a machine-readable instruction executable for the processor 701 (such as, the instructions correspondingly executed by the information acquisition module 601, the position determination module 602, the detection angle determination module 603, and the target detection module 604 in the target detection apparatus as shown in FIG. 6). When the electronic device runs, the processor 701 communicates with the memory 702 through the bus 703. The machine-readable instruction, when being executed by the processor 701, executes the following processing that: a plurality of frames of point cloud data obtained through scanning by a radar apparatus and time information of each frame of point cloud data obtained through scanning are acquired; position information of a target to be detected is determined based on each frame of point cloud data; scanning direction angle information when the target to be detected is scanned by the radar apparatus in each frame of point cloud data is determined based on the position information of the target to be detected in each frame of point cloud data; and moving information of the target to be detected is determined according to the position information of the target to be detected in each frame of point cloud data, the scanning direction angle information when the target to be detected is scanned by the radar apparatus in each frame of point cloud data, and the time information of each frame of point cloud data obtained through scanning.

The embodiments of the present disclosure further provide a computer-readable storage medium having a computer program stored thereon. The computer program is run by the processor to execute the steps of the target detection method in the abovementioned method embodiments. The computer-readable storage medium may be a nonvolatile or volatile computer readable storage medium.

A computer program product of the target detection method provided in the embodiments of the present disclosure includes a computer-readable storage medium having a program code stored thereon. An instruction included in the program code may be used to execute the steps of the target detection method as described in the abovementioned method embodiments. References may specifically be made to the abovementioned method embodiments and will not be elaborated here.

The embodiments of the present disclosure further provide a computer program. The computer program, when being executed by the processor, implements any method in the foregoing embodiments. The computer program product may be specifically realized by means of hardware, software or a combination thereof. In an optional embodiment, the computer program product is specifically embodied as a computer storage medium. In another optional embodiment, the computer program product is specifically embodied as software products, such as a Software Development Kit (SDK).

Those skilled in the art may clearly learn about that specific operating processes of the system and apparatus described above may refer to the corresponding processes in the method embodiment and will not be elaborated herein for convenient and brief description. In the several embodiments provided in the present disclosure, it should be understood that the disclosed system, apparatus, and method may be implemented in other manners. The apparatus embodiment described above is only schematic, and for example, division of the units is only logic function division, and other division manners may be adopted during practical implementation. For another example, a plurality of units or components may be combined or integrated into another system, or some characteristics may be neglected or not executed. In addition, the illustrated or discussed mutual couplings or direct couplings or communication connections may be implemented through some communications interfaces. The indirect couplings or communication connections between the apparatuses or modules may be implemented in electrical, mechanical, or other forms.

The units described as separate parts may or may not be physically separated, and parts illustrated as units may or may not be physical units, and namely may be located in the same place, or may also be distributed to multiple network units. Part or all of the units may be selected to achieve the purpose of the solutions of the embodiments according to a practical requirement.

In addition, functional units in various embodiments of the present disclosure may be integrated into a processing unit, each unit may also physically exist independently, and two or more than two units may also be integrated into a unit.

The function, when being realized in form of software functional unit and sold or used as an independent product, may be stored in a non-volatile computer-readable storage medium executable for the processor. Based on such an understanding, the technical solutions of the present disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device, or the like) to execute all or part of the steps of the method in each embodiment of the present disclosure. The foregoing storage medium includes: various media capable of storing program codes, such as a USB flash disc, a mobile hard disc, a Read-Only Memory (ROM), a Random Access Memory (RAM), a magnetic disc, or a compact disc.

It is finally to be noted that the above embodiments are only the specific implementations of the present disclosure and are adopted not to limit the present disclosure but to describe the technical solutions of the present disclosure. The scope of protection of the present disclosure is not limited thereto. Although the present disclosure is described with reference to the embodiments in detail, those of ordinary skill in the art should know that those skilled in the art may still make modifications or apparent variations to the technical solutions recorded in the embodiments or make equivalent replacements to part of technical features within the technical scope disclosed in the present disclosure, and these modifications, variations, or replacements do not make the essence of the corresponding technical solutions departs from the spirit and scope of the technical solutions of the embodiments of the present disclosure and shall fall within the scope of protection of the present disclosure. Therefore, the scope of protection of the present disclosure shall be subject to the scope of protection of the claims.

### INDUSTRIAL APPLICABILITY

The embodiments of the present disclosure disclose a target detection method and apparatus, an electronic device, and a storage medium. The target detection method includes that: a plurality of frames of point cloud data obtained through scanning by a radar apparatus and time information of each frame of point cloud data obtained through scanning are acquired; position information of a target to be detected is determined based on each frame of point cloud data; scanning direction angle information when the target to be detected is scanned by the radar apparatus in each frame of point cloud data is determined based on the position information of the target to be detected in each frame of point cloud data; and moving information of the target to be detected is determined according to the position information of the target to be detected in each frame of point cloud data, the scanning direction angle information when the target to be detected is scanned by the radar apparatus in each frame of point cloud data, and the time information of each frame of point cloud data obtained through scanning. In the abovementioned solution, the moving information of the target is determined in combination with the time information of each frame of point cloud data obtained through scanning and information related to a target to be detected in each frame of point cloud data, the accuracy is high.

1. A target detection method, comprising:
acquiring a plurality of frames of point cloud data obtained through scanning by a radar apparatus and time information of each frame of point cloud data obtained through scanning;
determining position information of a target to be detected based on each frame of point cloud data;
determining scanning direction angle information when the target to be detected is scanned by the radar apparatus in each frame of point cloud data based on the position information of the target to be detected in each frame of point cloud data; and
determining moving information of the target to be detected according to the position information of the target to be detected in each frame of point cloud data, the scanning direction angle information when the target to be detected is scanned by the radar apparatus in each frame of point cloud data, and the time information of each frame of point cloud data obtained through scanning.

2. The method of claim 1, wherein the time information of each frame of point cloud data obtained through scanning comprises scanning start and end time information and scanning start and end angle information corresponding to each frame of point cloud data,
and wherein determining the moving information of the target to be detected according to the position information of the target to be detected in each frame of point cloud data, the scanning direction angle information when the target to be detected is scanned by the radar apparatus in each frame of point cloud data, and the time information of each frame of point cloud data obtained through scanning comprises:
determining the moving information of the target to be detected according to the position information of the target to be detected in each frame of point cloud data, the scanning direction angle information when the target to be detected is scanned by the radar apparatus in each frame of point cloud data, and the scanning start and end time information and the scanning start and end angle information corresponding to each frame of point cloud data.

3. The method of claim 2, wherein determining the moving information of the target to be detected according to the position information of the target to be detected in each frame of point cloud data, the scanning direction angle information when the target to be detected is scanned by the radar apparatus in each frame of point cloud data, and the scanning start and end time information and the scanning start and end angle information corresponding to each frame of point cloud data comprises:
for each frame of point cloud data, determining scanning time information when the target to be detected is scanned in the frame of point cloud data based on the scanning direction angle information when the target to be detected is scanned in the frame of point cloud data, and the scanning start and end time information and the scanning start and end angle information corresponding to the frame of point cloud data;
determining displacement information of the target to be detected based on the position information of the target to be detected in the plurality of frames of point cloud data; and
determining moving speed information of the target to be detected based on scanning time information when the target to be detected is scanned respectively in the plurality of frames of point cloud data and the displacement information of the target to be detected.

4. The method of claim 3, wherein for each frame of point cloud data, determining the scanning time information when the target to be detected is scanned in the frame of point cloud data based on the scanning direction angle information when the target to be detected is scanned in the frame of point cloud data, and the scanning start and end time information and the scanning start and end angle information corresponding to the frame of point cloud data comprises:
for each frame of point cloud data,
determining a first angle difference between a direction angle for the target to be detected and a scanning start angle based on the scanning direction angle information when the target to be detected is scanned in the frame of point cloud data and scanning start angle information in the scanning start and end angle information corresponding to the frame of point cloud data;
determining a second angle difference between a scanning end angle and a scanning start angle based on the scanning start angle information and scanning end angle information in the scanning start and end angle information corresponding to the frame of point cloud data;
determining, based on scanning end time information when scanning of the frame of point cloud data is ended in the scanning start and end time information corresponding to the frame of point cloud data and scanning start time information when the scanning of the frame of point cloud data is started in the scanning start and end time information corresponding to the frame of point cloud data, a time difference between the scanning end time information and the scanning start time information; and
determining the scanning time information when the target to be detected is scanned in the frame of point cloud data based on the first angle difference, the second angle difference, the time difference, and the scanning start time information.

5. The method of claim 3, further comprising:
controlling, based on the moving speed information of the target to be detected and speed information of an intelligent device provided with the radar apparatus, the intelligent device.

6. The method of claim 1, further comprising:
predicting a movement trajectory of the target to be detected in a future time period based on the moving information and historical movement trajectory information of the target to be detected.

7. The method of claim 1, wherein determining the position information of the target to be detected based on each frame of point cloud data comprises:
performing gridding processing on each frame of point cloud data to obtain a grid matrix, wherein a value of each element in the grid matrix is used to represent whether a point-cloud point exists in a grid corresponding to the element;
generating a sparse matrix corresponding to the target to be detected according to the grid matrix and size information of the target to be detected; and
determining the position information of the target to be detected based on the generated sparse matrix.

8. The method of claim 7, wherein generating the sparse matrix corresponding to the target to be detected according to the grid matrix and the size information of the target to be detected comprises:
performing, according to the grid matrix and the size information of the target grabbing to be detected, at least one dilating processing operation or at least one eroding processing operation on one or more target elements in the grid matrix, to generate the sparse matrix corresponding to the target to be detected, wherein
the target element represents an element that a point-cloud point exists in a grid corresponding to the element.

9. The method of claim 8, wherein performing, according to the grid matrix and the size information of the target to be detected, the at least one dilating processing operation or the at least one eroding processing operation on the one or more target elements in the grid matrix, to generate the sparse matrix corresponding to the target to be detected comprises:
performing at least one shift processing and at least one logical operation processing on the one or more target elements in the grid matrix to obtain the sparse matrix corresponding to the target to be detected, wherein a difference value between a size of a coordinate range of the obtained sparse matrix and the size of the target to be detected is within a pre-set threshold range.

10. The method of claim 8, wherein performing, according to the grid matrix and the size information of the target to be detected, at least one dilating processing operation on the one or more target elements in the grid matrix, to generate the sparse matrix corresponding to the target to be detected comprises:
performing a first negation operation on elements in a grid matrix before a current dilating processing operation, to obtain a grid matrix after the first negation operation;
performing at least one convolution operation on the grid matrix after the first negation operation based on a first preset convolution kernel, to obtain a grid matrix with preset sparsity after the at least one convolution operation, wherein the preset sparsity is determined by the size information of the target to be detected; and
performing a second negation operation on elements in the grid matrix with the preset sparsity after the at least one convolution operation, to obtain the sparse matrix.

11. The method of claim 10, wherein performing the first negation operation on the elements in the grid matrix before the current dilating processing operation, to obtain the grid matrix after the first negation operation comprises:
performing a convolution operation on one or more other elements, other than the one or more target elements, in the grid matrix before the current dilating processing operation based on a second preset convolution kernel, to obtain one or more first negated elements, and
performing a convolution operation on the one or more target elements in the grid matrix before the current dilating processing operation based on the second preset convolution kernel, to obtain one or more second negated elements; and
obtaining the grid matrix after the first negation operation based on the one or more first negated elements and the one or more second negated elements.

12. The method of claim 10, wherein the performing the at least one convolution operation on the grid matrix after the first negation operation based on the first preset convolution kernel, to obtain the grid matrix with the preset sparsity after the at least one convolution operation comprises:
performing, for a first convolution operation, a convolution operation on the grid matrix after the first negation operation and the first preset convolution kernel, to obtain a grid matrix after the first convolution operation;
determining whether sparsity of the grid matrix after the first convolution operation reaches the preset sparsity; and
if not, repeatedly executing the operation of performing the convolution operation on a grid matrix after a last convolution operation and the first preset convolution kernel to obtain a grid matrix after a current convolution operation, until the grid matrix with the preset sparsity after the at least one convolution operation is obtained.

13. The method of claim 12, wherein the first preset convolution kernel has a weight matrix and an offset corresponding to the weight matrix, and the performing, for the first convolution operation, the convolution operation on the grid matrix after the first negation operation and the first preset convolution kernel, to obtain the grid matrix after the first convolution operation comprises:
for the first convolution operation, selecting all grid sub-matrixes from the grid matrix after the first negation operation according to a size of the first preset convolution kernel and a preset step size;
for each grid sub-matrix which is selected, multiplying the grid sub-matrix and the weight matrix to obtain a first operation result, and performing an addition operation on the first operation result and the offset to obtain a second operation result; and
determining the grid matrix after the first convolution operation based on second operation results corresponding to all the grid sub-matrixes.

14. The method of claim 8, wherein performing, according to the grid matrix and the size information of the target to be detected, the at least one eroding processing operation on the one or more target elements in the grid matrix, to generate the sparse matrix corresponding to the target to be detected comprises:
performing at least one convolution operation on the grid matrix to be processed based on a third preset convolution kernel, to obtain a grid matrix with preset sparsity after the at least one convolution operation, wherein the preset sparsity is determined by the size information of the target to be detected; and
determining the grid matrix with the preset sparsity after the at least one convolution operation as the sparse matrix corresponding to the target to be detected.

15. The method of claim 7, wherein the performing the gridding processing on each frame of point cloud data to obtain the grid matrix comprises:
performing the gridding processing on each frame of point cloud data, to obtain the grid matrix and corresponding relationships between elements in the grid matrix and coordinate range information of point-cloud points;
determining the position information of the target to be detected based on the generated sparse matrix comprises:
determining coordinate information corresponding to each target element in the generated sparse matrix based on the corresponding relationships between elements in the grid matrix and coordinate range information of point-cloud points; and
combining coordinate information corresponding to all target elements in the sparse matrix to determine the position information of the target to be detected.

16. The method of claim 7, wherein determining the position information of the target to be detected based on the generated sparse matrix comprises:
performing at least one convolution processing on each target element in the generated sparse matrix based on a trained convolutional neural network, to obtain a convolution result; and
determining the position information of the target to be detected based on the convolution result.

17. An electronic device, comprising:
a processor;
a memory having a machine-readable instruction executable for the processor stored thereon; and
a bus, wherein when the electronic device runs, the processor communicates with the memory through the bus and the machine-readable instruction, when being executed by the processor, causes the processor to execute the following operations:
acquiring a plurality of frames of point cloud data obtained through scanning by a radar apparatus and time information of each frame of point cloud data obtained through scanning;
determining position information of a target to be detected based on each frame of point cloud data;
determining scanning direction angle information when the target to be detected is scanned by the radar apparatus in each frame of point cloud data based on the position information of the target to be detected in each frame of point cloud data; and
determining moving information of the target to be detected according to the position information of the target to be detected in each frame of point cloud data, the scanning direction angle information when the target to be detected is scanned by the radar apparatus in each frame of point cloud data, and the time information of each frame of point cloud data obtained through scanning.

18. The electronic device of claim 17, wherein the time information of each frame of point cloud data obtained through scanning comprises scanning start and end time information and scanning start and end angle information corresponding to each frame of point cloud data,
and wherein the machine-readable instruction, when being executed by the processor, causes the processor to:
determine the moving information of the target to be detected according to the position information of the target to be detected in each frame of point cloud data, the scanning direction angle information when the target to be detected is scanned by the radar apparatus in each frame of point cloud data, and the scanning start and end time information and the scanning start and end angle information corresponding to each frame of point cloud data.

19. The electronic device of claim 18, the machine-readable instruction, when being executed by the processor, causes the processor to:
for each frame of point cloud data, determine scanning time information when the target to be detected is scanned in the frame of point cloud data based on the scanning direction angle information when the target to be detected is scanned in the frame of point cloud data, and the scanning start and end time information and the scanning start and end angle information corresponding to the frame of point cloud data;
determine displacement information of the target to be detected based on the position information of the target to be detected in the plurality of frames of point cloud data; and
determine moving speed information of the target to be detected based on scanning time information when the target to be detected is scanned respectively in the plurality of frames of point cloud data and the displacement information of the target to be detected.

20. A computer readable storage medium having a computer program stored thereon, wherein the computer program, when run by a processor, executes the following operations:
acquiring a plurality of frames of point cloud data obtained through scanning by a radar apparatus and time information of each frame of point cloud data obtained through scanning;
determining position information of a target to be detected based on each frame of point cloud data;
determining scanning direction angle information when the target to be detected is scanned by the radar apparatus in each frame of point cloud data based on the position information of the target to be detected in each frame of point cloud data; and
determining moving information of the target to be detected according to the position information of the target to be detected in each frame of point cloud data, the scanning direction angle information when the target to be detected is scanned by the radar apparatus in each frame of point cloud data, and the time information of each frame of point cloud data obtained through scanning.
